(19) United States
(12) Patent Application Publication
(10) Pub. No.: US 2005/0058071 A1
(43) Pub. Date: Mar. 17, 2005

(54) Optical access system

(76) Inventors: Katsuhiko Hirashima, Kanagawa (JP); Kazuhiro Uchida, Kanagawa (JP); Masamichi Kasa, Kanagawa (JP); Susumu Tominaga, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/728,107

(22) Filed: Dec. 3, 2003

(30) Foreign Application Priority Data
Dec. 3, 2002 (JP) 2002-350737

(51) Int. Cl. H04L 12/26

(52) U.S. Cl. 370/235

(57) ABSTRACT

An optical access system that sends packets in a given time slot more efficiently without wasting bandwidth. The uplink channel from slave devices to a master device is divided into time slots. The sending slave device reads out upstream packets from its send packet buffer when an assigned time slot comes. If the maximum frame size is reached in the middle of a packet, the slave device suspends further reading until a next assigned time slot comes. The packets are sent to the master device, each being set off by a start and end delimiters. Detection of a start delimiter causes the master device to begin writing each received data word into a receive packet buffer, which is terminated by the end delimiter of that packet. Received packets are retrieved from their memory locations specified by a read address that includes the sender's slave device number.

### BACKGROUND OF THE INVENTION

1. Field of the Invention

The present invention relates to an optical access system, and more particularly to an optical access system that connects subscriber premises to their nearest central office by using optical communications techniques.

2. Description of the Related Art

Recent years have seen an increased interest in optical access systems known as the “Fiber to the Home” (FTTH) service, which run a fiber from the central office to every subscriber's home. Particularly, passive optical network (PON) systems are expected to receive wide acceptance in the market in the near future because of their low fiber deployment costs. Applications such as video on demand, CATV, and high-speed computer access require wideband communication channels to customers' premises. Optical access systems are essential to offer those bandwidth-intensive services at low prices, and thus they are rapidly deployed as part of the next-generation network infrastructures.

FIG. 25 is a simplified block diagram of a PON-based optical access system. This system 100 includes a plurality of slave devices 111-1 to 111-n in subscriber premises 110-1 to 110-n and a master device 121 in their nearest central office 120. The master device 121 and slave devices 111-1 to 111-n exchange optical burst signals back and forth. The slave devices 111-1 to 111-n are coupled to personal computers or other end systems, while the master device 121 is coupled to a telephone exchange 122. The star coupler 130 connects each slave device 111-1 to 111-n with the master device 121.

In downlink (master to slave) transmission, the central office 120 broadcasts downstream data toward the subscriber premises 110-1 to 110-n over a single optical fiber cable. The star coupler 130 splits the optical signal into a plurality of signals for delivery to the individual subscribers through multiple branching fiber link cables. In uplink (slave to master) transmission, the slave devices in the subscriber premises 110-1 to 110-n place upstream signals on their respective fiber links. The star coupler 130 directs those signals into a single fiber cable for delivery to the central office 120. As can be seen from the above, the optical access system 100 provides 1:n network connections between a central office and multiple subscriber premises, using optical distribution techniques.

In such conventional systems, the uplink channel is divided into multiple time slots for shared use by a plurality of slave devices. Each slave device puts uplink packets in its assigned time slot in the order that the master device will receive them. When the amount of upstream packets-exceeds the limit that a single time slot can carry at a time (i.e., the maximum frame size), it waits the next assigned time slot to deliver the overflowing packets.

FIG. 26 shows the structure of conventional upstream transmission frames, which travel on the upstream-side portion of the fiber optic link after being combined into a single bitstream by the star coupler 130. The bitstream begins with a timing control preamble, which is followed by a plurality of time slots TS1 to TSn. As mentioned, each time slot limits the maximum frame size. Slave devices insert packets into different time slots assigned to them, in the order that they should arrive at the master device. The example of FIG. 26 assumes that the sending slave device has been assigned time slots TS1 and TS3 and now has three packets P1, P2, and P3 to be sent in that order. It is also assumed that one time slot can carry one or two packets, but not three. The sending slave device thus puts the first two packets P1 and P2 in the first time slot TS1, and the remaining packet P3 in the next assigned time slot TS3. This leaves, however, some amount of unused space in the first time slot TS1 as shown in FIG. 26.

As can be seen from the above, the slave devices assemble variable-length frames for uplink transmission, each frame being limited within a time slot period. When there are too many packets to fit in one slot, the conventional slave device uses a next assigned time slot to deal with overflowing packets. This inevitably wastes some amount of time slot resources, depending on the number and size of packets to be transmitted.

FIG. 27 shows a worst situation where the time slots of FIG. 26 are used most inefficiently. In this example, one subscriber terminal is sending a series of packets P1 to P6, each being one byte longer than half the time slot length. Each slot, however, can convey only one packet at a time. Even though the slave device is assigned consecutive time slots TS1 to TS6 on the uplink channel, almost half of them are left unused. That is, the bandwidth usage is as low as 50 percent in this case. Also, the slave device is required to have a large temporary storage space for buffering incoming packets that could overflow. However, having such buffer storage in every slave device leads to increased hardware requirements and longer latency times.

Some researchers propose a packet processing technique with improved efficiency. See, for example, the Unexamined Japanese Patent Publication No. 7-221762 (1995), paragraphs 0012 to 0020 and FIG. 1. According to this literature, a buffer memory is divided into a plurality of banks, each being able to accommodate multiple fixed-length data blocks. Those banks may be organized in a list structure using pointers. When the size of a variable-length frame exceeds the bank size, the frame is stored in a plurality of structured banks of the buffer memory. Packets are then produced by reading out each data block from one of those structured banks.

Unfortunately, it is not realistic to use the above-described conventional technique (Unexamined Japanese Patent Publication No. 7-221762) in PON systems, which are designed for point-to-multipoint access networks. More specifically, the proposed system uses a buffer management table for reconstructing a variable-length frame from packets. To support multiple network devices, however, the system has to have as many management tables as the number of devices. This complicates the structure of a system and requires more intricate packet processing tasks.

### SUMMARY OF THE INVENTION

In view of the foregoing, it is an object of the present invention to provide an optical access system that can send packets more efficiently without wasting bandwidth.

To accomplish the above object, the present invention provides an optical access system that connects subscriber premises with a central office by using optical communications techniques. This optical access system comprises a slave device and a master device. The slave device, identified by a slave device number, has the following elements: a send packet buffer that stores packets to be sent; a sending-end write controller that writes a packet in the send packet buffer; a capacity monitor that watches usage of the send packet buffer and outputs a capacity indicator representing the amount of unused memory space in the send packet buffer; an upstream frame timing controller that produces a frame signal representing a bandwidth allocated to the slave device for upstream data transmission, the frame signal being active during a period corresponding to a maximum frame size; and a sending-end read controller that reads the packets out of the send packet buffer when the frame signal is active and the capacity indicator indicates presence of packets pending in the send packet buffer, wherein the sending-end read controller suspends the reading of packets when the maximum frame size is reached and resumes the suspended reading next time the frame signal becomes active. The master device, on the other hand, has the following elements: a receive packet buffer that stores packets received from the slave device in a memory space that is associated with the slave device number of the sending slave device; a delimiter detector that produces a start signal upon detection of a start delimiter of a received packet, and an end signal upon detection of an end delimiter of the received packet; a receiving-end write controller that starts writing the received packet into the receive packet buffer upon receipt of the start signal from the delimiter detector and stops writing the received packet into the receive packet buffer upon receipt of the end signal from the delimiter detector; a read request unit that issues a read request for the received packet upon issuance of the end signal; and a receiving-end read controller that reads, in response to the read request, the received packet out of the memory space of the receive packet buffer by giving a read address that includes the slave device number of the slave device.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of an optical access system according to the present invention.

FIG. 2 shows the structure of a slave device.

FIG. 3 is a timing diagram showing write control operations.

FIG. 4 shows the structure of a packet buffer in a slave device.

FIG. 5 shows the structure of a packet size table.

FIG. 6 is a timing diagram showing read control operations.

FIG. 7 schematically shows how a slave device divides and sends packets.

FIG. 8 is a timing diagram showing how a slave device divides and sends packets.

FIG. 9 shows the structure of a master device.

FIG. 10 schematically shows how the master device operates.

FIGS. 11 to 13 are timing diagrams showing how the master device operates.

FIG. 14 shows the structure of an address backup register.

FIG. 15 shows the structure of a packet buffer in the master device.

FIG. 16 shows the structure of a read queue.

FIGS. 17 and 18 show the structure of a slave device.

FIG. 19 shows how packets are written in a packet buffer.

FIG. 20 shows a packet size table.

FIG. 21 shows an example of packets stored in the packet buffer.

FIG. 22 shows a state of the packet size table.

FIG. 23 shows a process of searching for a packet that fits in a remaining space.

FIG. 24 shows the structure of packet headers.

FIG. 25 is a simplified block diagram of a conventional optical access system.

FIG. 26 shows the structure of conventional upstream transmission frames.

FIG. 27 shows a worst case where time slots are used most inefficiently.

### DESCRIPTION OF THE PREFERRED EMBODIMENTS

Preferred embodiments of the present invention will be described below with reference to the accompanying drawings, wherein like reference numerals refer to like elements throughout.

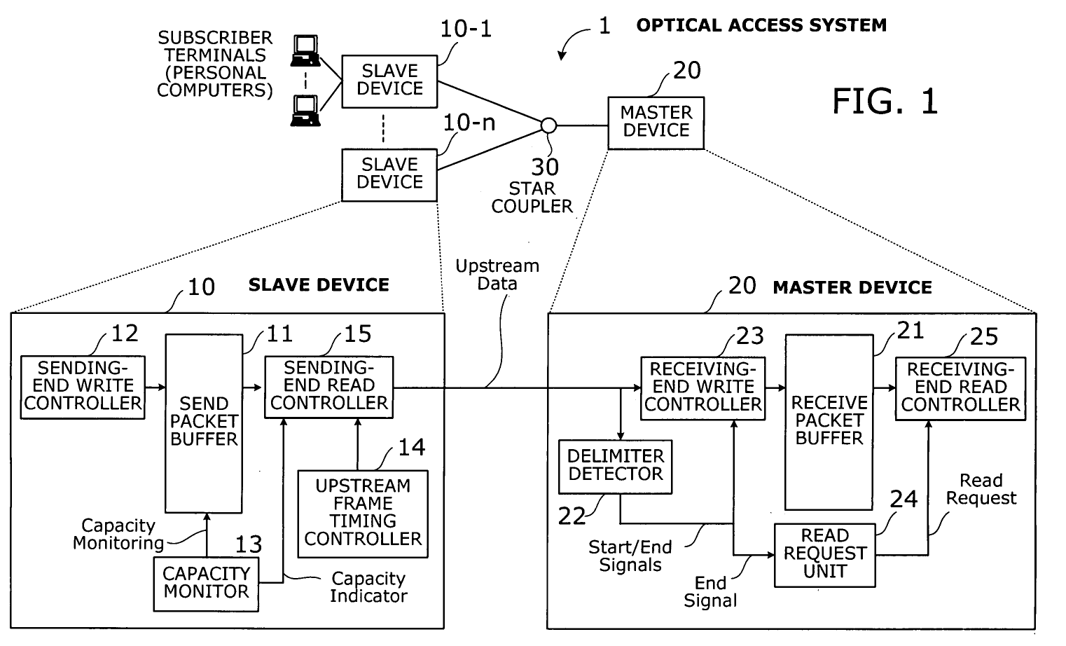

FIG. 1 is a conceptual view of an optical access system according to the present invention. This optical access system 1 takes a PON configuration, in which a plurality of slave devices 10-1 to 10-n (referred to collectively by the reference numeral “10”) can interact with their master device 20 through a star coupler 30. Each slave device 10 serves one or more subscriber terminals such as personal computers.

The lower left quadrant of FIG. 1 shows details of the slave devices 10. According to the present invention, each slave device 10 employs the following elements: a send packet buffer 11, a sending-end write controller 12, a capacity monitor 13, an upstream frame timing controller 14, and a sending-end read controller 15. Those elements provides the following functions:

The send packet buffer 11 stores outgoing packets from subscriber terminals, which are constructed in the form of, for example, Ethernet^{(R)} packets. The sending-end write controller 12 writes packet data words, including headers, into the send packet buffer 11. The capacity monitor 13 watches the occupancy of the send packet buffer 11 and outputs a capacity indicator that indicates how much memory space remains unused. The upstream frame timing controller 14 outputs a frame signal that indicates how much bandwidth is assigned for transmission of upstream data. More specifically, the frame signal indicates the time slot length (or maximum frame size); it becomes active during a period when the slave device 10 is allowed to use the uplink channel to send its outgoing Ethernet packets. The sending-end read controller 15 reads out packet data words from the send packet buffer 11 when the frame signal is active and the capacity indicator indicates the presence of unsent packets pending in said send packet buffer 11. When the maximum frame size is reached in the course of data reading operation, the sending-end read controller 15 stops reading and waits until the frame signal becomes active again.

The lower right quadrant of FIG. 1 shows details of the master device 20. According to the present invention, the master device 20 has the following elements: a receive packet buffer 21, a delimiter detector 22, a receiving-end write controller 23, a read request unit 24, and a receiving-end read controller 25. The functions of those elements are as follows:

The receive packet buffer 21 stores packets received from slave devices 10. Actually, its memory space is divided into a plurality of sections, each being assigned to one slave device. The delimiter detector 22 detects the start and end delimiters of a received packet, thus generating a start signal and an end signal, respectively. When the frame signal is active, the receiving-end write controller 23 starts writing packet data words in the receive packet buffer 21 in response to the start signal and finishes writing them in response to the end signal. Upon issuance of an end signal, the read request unit 24 requests the receiving-end read controller 25 to read out a packet. In response to this read request signal, the receiving-end read controller 25 reads a packet out of the receive packet buffer 21, supplying a read address associated with the intended slave device. More specifically, the read address includes the slave device number of that device to specify which section of the receive packet buffer to select.

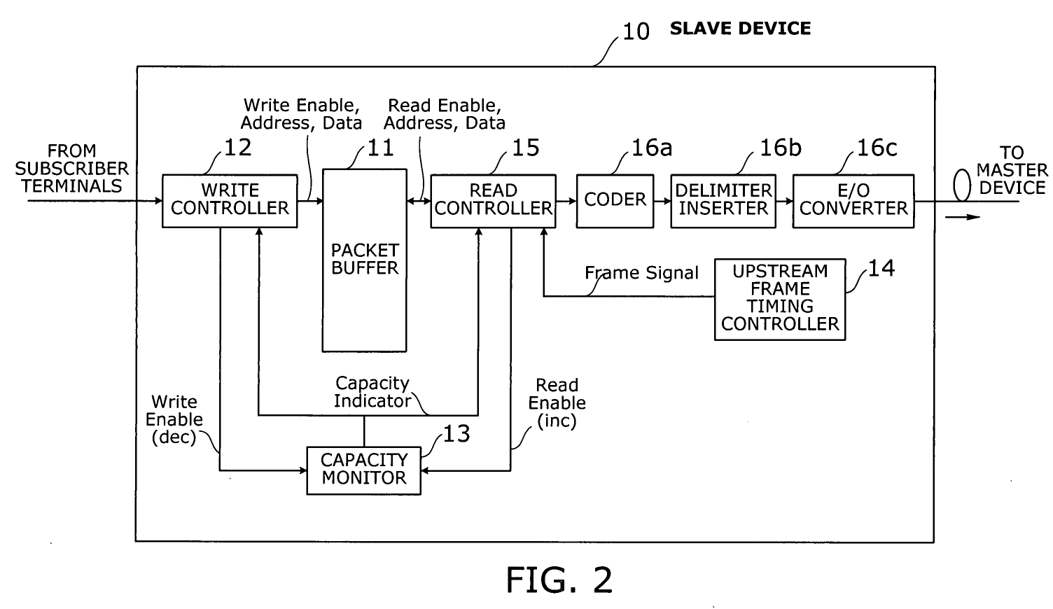

Referring next to FIGS. 2 to 8, the structure and detailed functions of slave devices 10 will be described below.

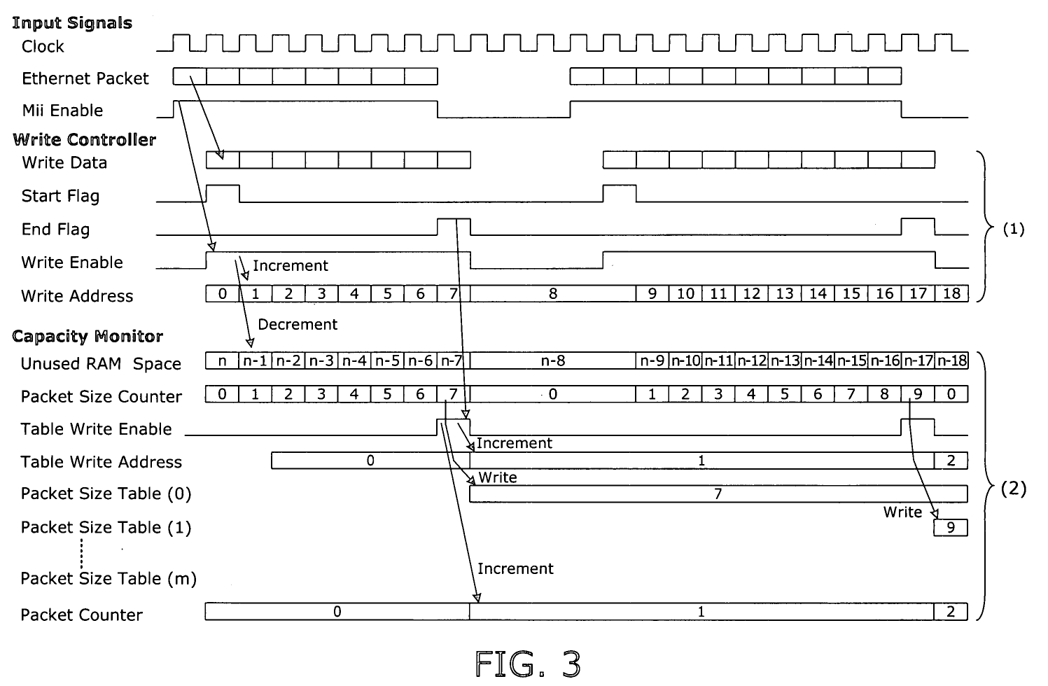

FIG. 2 shows the structure of a slave device 10, and FIG. 3 is a timing diagram that shows how it controls write operation to its integral packet buffer. The slave device 10 has the following elements: a packet buffer 11 (what we have described as the send packet buffer 11 in FIG. 1), a write controller 12 (sending-end write controller 12 in FIG. 1), a capacity monitor 13, an upstream frame timing controller 14, a read controller 15 (sending-end read controller 15 in FIG. 1), a coder 16a, a delimiter inserter 16b, and an electrical-to-optical (E/O) converter 16c.

When a packet comes from its local subscriber terminals, the slave device 10 commands its write controller 12 to store the received packet in the packet buffer 11. The packet buffer 11 is organized with random access memory (RAM) devices, which is controlled by the write controller 12 as shown in part (1) of FIG. 3. The write controller 12 supplies the packet buffer 11 with received packets as write data, generating a write enable signal that indicates the presence of packet data words and incrementing the write address while the write enable is asserted. The write controller 12 also marks the first write data word of a packet with a start flag, as well as the last write data word with an end flag.

Each write to the packet buffer 11 triggers the capacity monitor 13 to check the unused space in there (i.e., free RAM size), as well as the size and number of packets written in the packet buffer 11, as shown in part (2) of FIG. 3. The write enable signal produced by the write controller 12 is routed also to the capacity monitor 13, for use in decrementing the capacity indicator, which represents the current free RAM size. The resulting free RAM size information is passed back to the write controller 12. When the free RAM size is no greater than the maximum packet length, the write controller 12 recognizes that the packet buffer 11 can accept no further data, and it thus sends a PAUSE packet to subscribers.

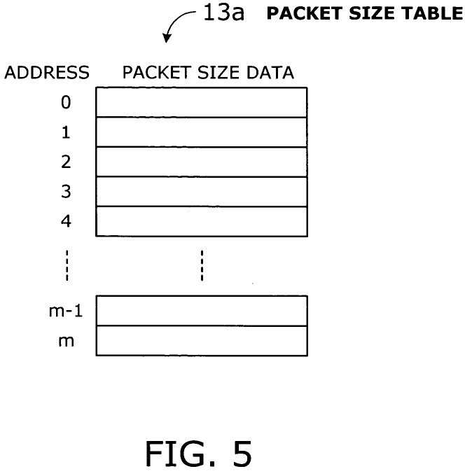

The capacity monitor 13 has a packet size counter to measure the length of a packet by counting data words while the write enable is active. The counter stops when the write enable is negated, the final count value indicating the packet size. The packet size obtained in this way is registered with a packet size table 13a (shown later in FIG. 5). The end flag produced by the write controller 12 is used as a write enable signal for the capacity monitor 13 to add a new entry to the packet size table 13a. More specifically, the write enable signal causes the newly obtained packet size value to be written in a table space that is specified by a write address pointer. The write address pointer is incremented after the write enable signal is negated.

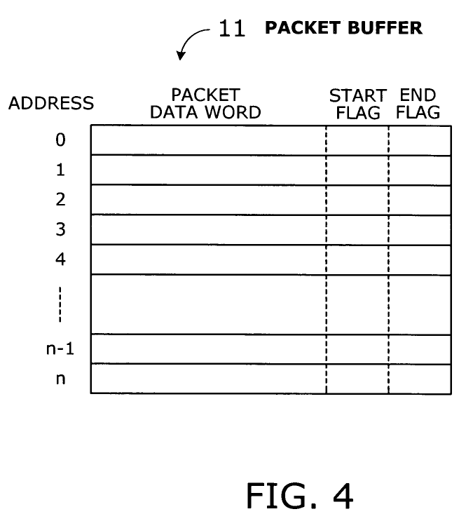

FIG. 4 shows the structure of the packet buffer 11. Each entry of this packet buffer 11 is composed of a data field, a start flag field, and an end flag field. FIG. 5 shows the structure of the packet size table 13a. As mentioned, the packet size table 13a is part of the capacity monitor 13 and used to record the size of each packet in the packet buffer 11.

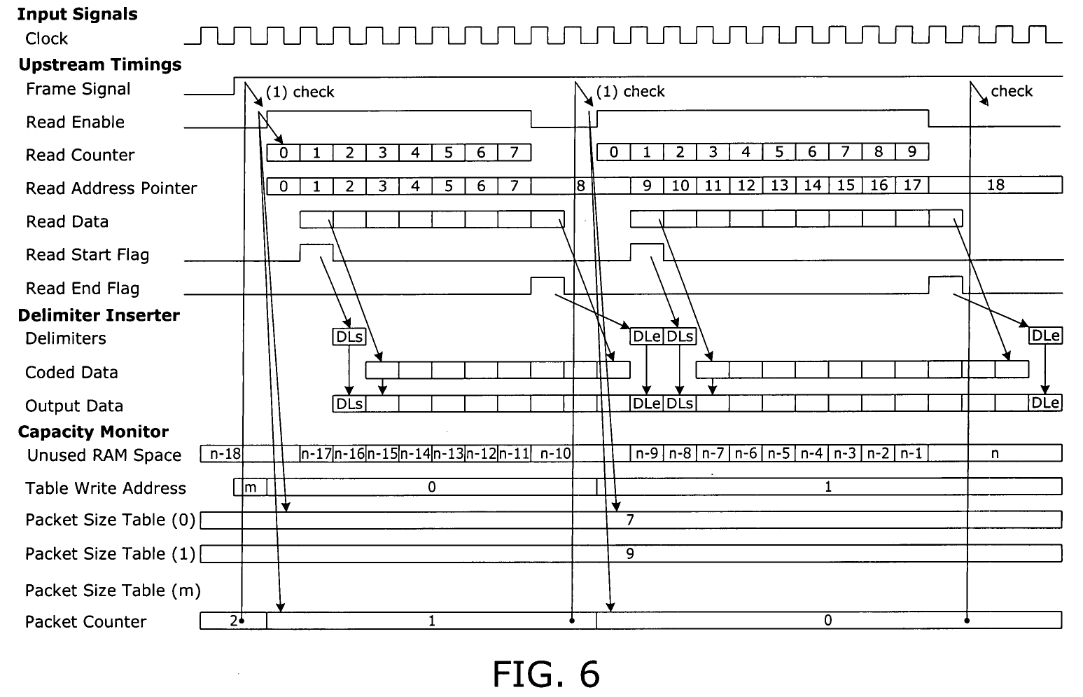

FIG. 6 is a timing diagram of read control operations. When the slave device 10 receives a time slot allocation from the central office, its read controller 15 reads out the packets stored in the packet buffer 11 and sends them to the central office. The details are as follows:

The upstream frame timing controller 14 outputs a frame signal during a time slot allocated by the central office. When this frame signal is active, and when there has been no read operation from the packet buffer 11 since two clock cycles ago, the read controller 15 makes access to the capacity monitor 13 to check its packet counter. If the packet counter exhibits a non-zero value, it means that the packet buffer 11 has at least one unsent packet. The read controller 15 thus gives a read enable signal to the packet buffer 11, as well as issuing a command to decrement the packet counter and increment the table read address pointer. It also initializes a read counter to zero, as indicated by the arrow (1) in FIG. 6. This read counter, an integral part of the read controller 15, is incremented each time a data word is read out from the packet buffer 11 during the period when the read enable signal is active. The read counter value is compared with an entry of the packet size table that is currently selected by a table read address pointer. When the read counter value has reached the packet size value in the table, the read controller 15 negates the read enable signal, thus terminating read operation for a single packet length as indicated by the arrow (2) in FIG. 6.

The packet buffer 11 outputs packet data words, together with start and end flags, with the read address incremented during the period when the read enable signal is active. The start flag and end flag are then supplied to the delimiter inserter 16b to produce a start delimiter DLs and an end delimiter DLe, respectively. For upstream transmission, the delimiter inserter 16b gives a one-clock delay to the start delimiter DLs and a three-clock delay to the end delimiter DLe. The packet data words read out of the packet buffer 11, on the other hand, are subjected to the 4B5B conversion at the coder 16a. Finally, the start delimiter DLs, 4B5B-coded packets, and end delimiter DLe are combined into an output bitstream for transmission over the upstream optical link.

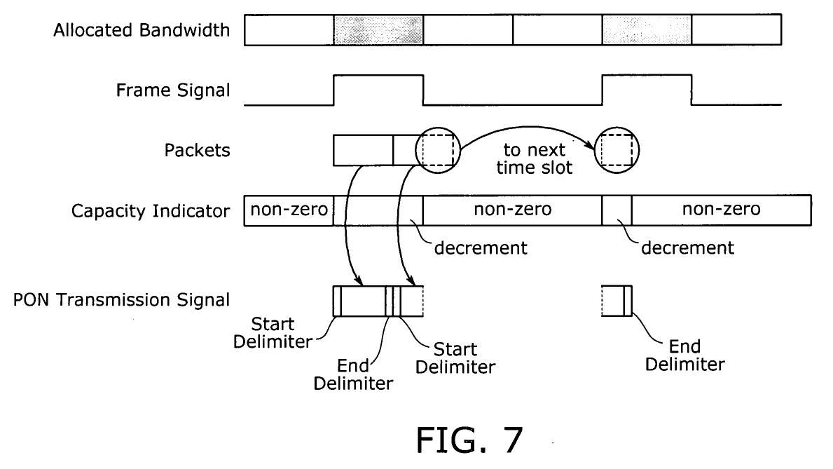

The above example of FIG. 6 has shown the case where the frame signal stays at an active state while all packets are read. Actually, however, the packet buffer may not always be cleared before the time slot comes to an end; it can happen that the time slot expires in the middle of a packet being read out of the packet buffer. FIG. 7 schematically shows how a slave device divides and sends packet data in such situations. In short, the read operation is suspended at the falling edge of the frame signal (i.e., the end of the current time slot) and resumed at the next rising edge of the frame signal (i.e., the beginning of the next time slot assigned to the same slave device).

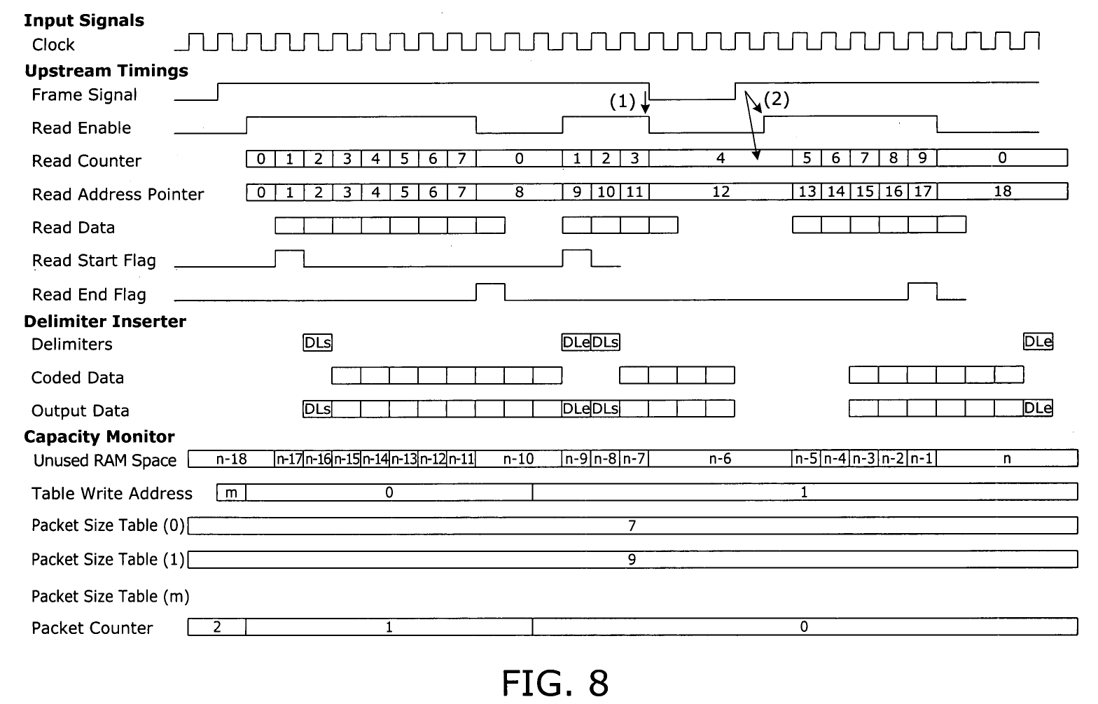

FIG. 8 is a timing diagram that explains the process in greater detail. The arrow (1) in this diagram indicates that the upstream frame timing controller 14 negates the frame signal because the time slot assigned to the slave device 10 has expired. The read controller 15 negates the read enable signal accordingly, which disables further updates to the read counter and read address pointer, thus freezing the read operation from the packet buffer 11.

When the upstream frame timing controller 14 asserts the frame signal again, the read controller 15 examines the read counter as indicated by the arrow (2) in FIG. 8. This timing is the same as that of checking the packet counter in the capacity monitor 13. If the read counter has a non-zero value, the read enable signal is asserted again, which permits the read counter and read address pointer to revive.

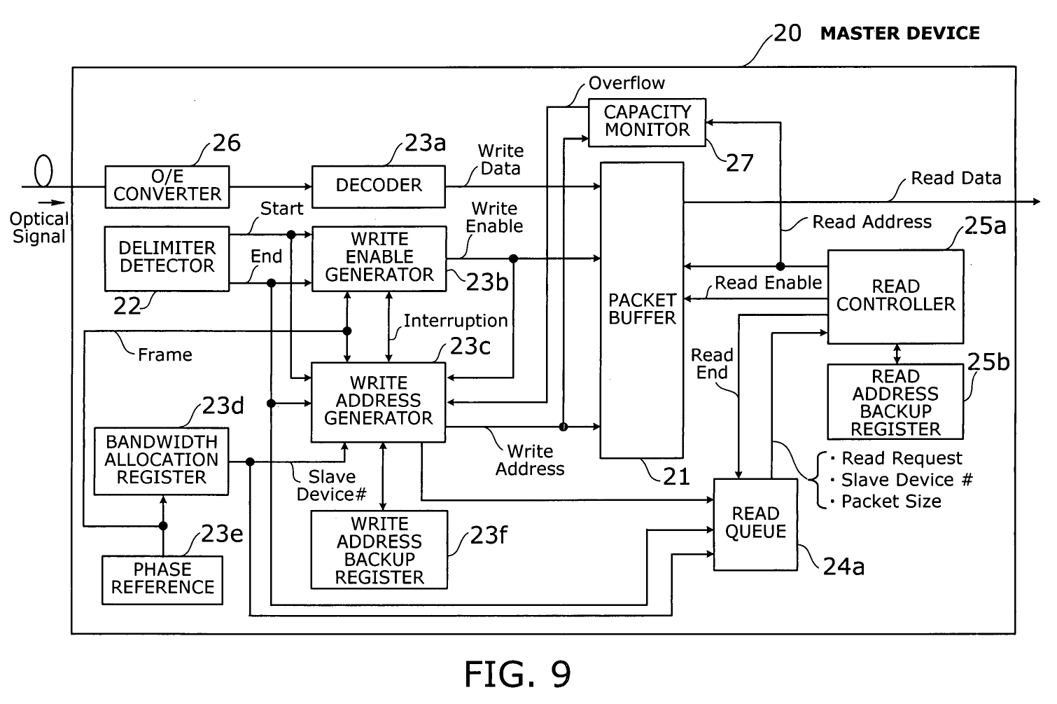

Referring next to FIGS. 9 to 16, the structure and detailed functions of the master device 20 will be described below.

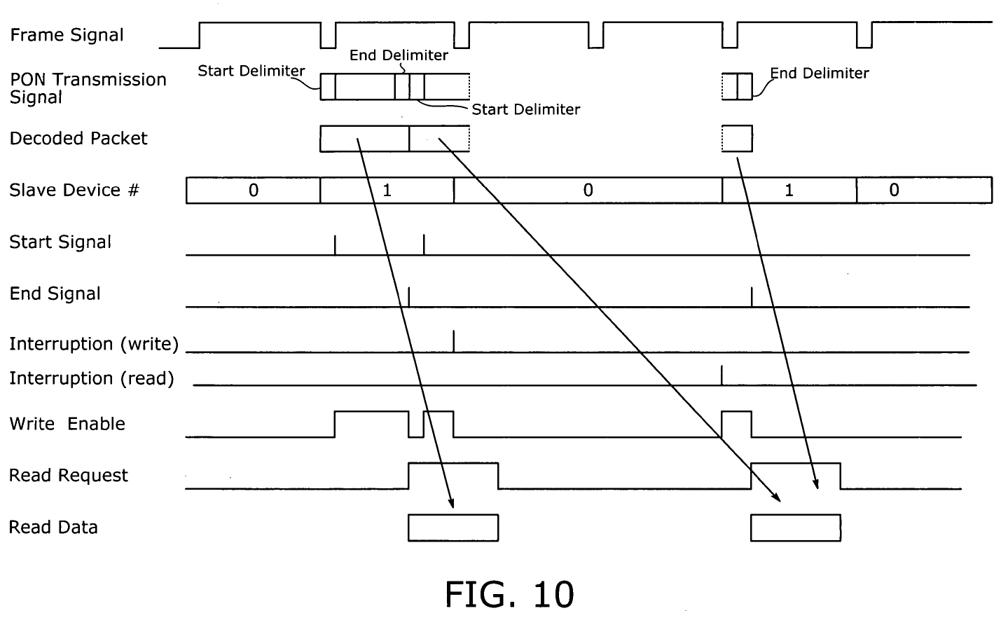

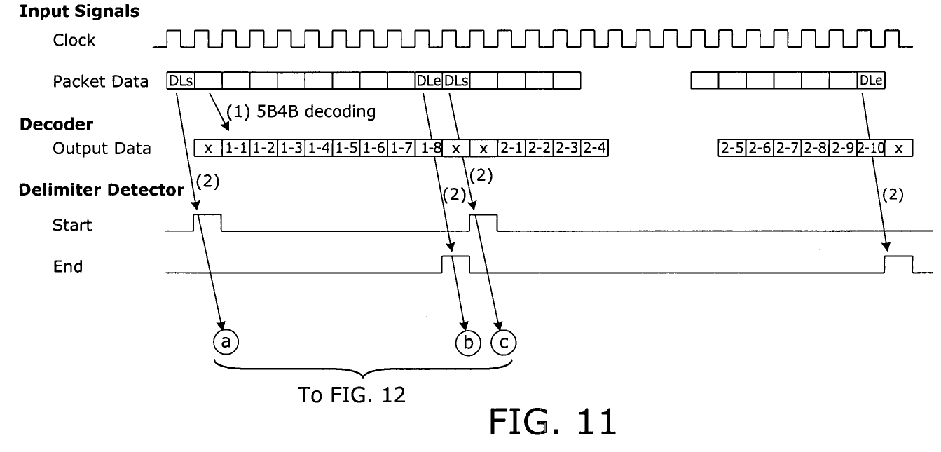

FIG. 9 shows the structure of the master device 20, and FIG. 10 schematically shows its operation. FIGS. 11 to 13 are timing diagrams explaining how the master device 20 operates. The master device 20 shown in FIG. 9 has the following elements: a packet buffer 21 (receive packet buffer 21 in FIG. 1), a delimiter detector 22, a decoder 23a, a write enable generator 23b, a write address generator 23c, a bandwidth allocation register 23d, a phase reference 23e, a write address backup register 23f, read queue 24a, a read controller 25a, a read address backup register 25b, an optical-to-electrical (O/E) converter 26, and a capacity monitor 27. Compared to what we discussed in FIG. 1, the elements 23a to 23f in FIG. 9 are functions of the receiving-end write controller 23 in FIG. 1, and the read queue 24a belongs to the read request unit 24. Also, the read controller 25a and read address backup register 25b correspond to the receiving-end read controller 25.

The master device 20 receives a coded bitstream from the PON and decodes it with the decoder 23a as indicated by the arrow (1) in FIG. 11. The decoded data is directed to the packet buffer 21. The delimiter detector 22 watches the incoming coded data, and when a start and end delimiters are detected, it produces start and end signals, respectively, as indicated by the arrows (2) in FIG. 11.

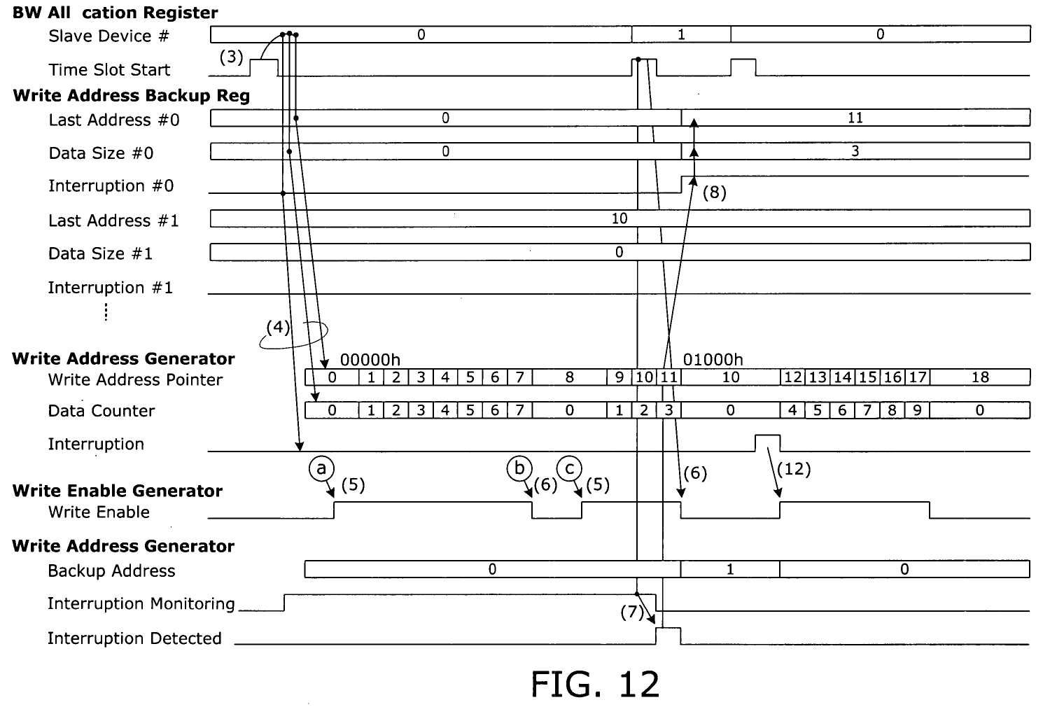

The phase reference 23e is a free-running counter that defines the cycle period of uplink frames, providing reference phase information. The bandwidth allocation register 23d maintains the information about how the master device 20 has allocated uplink bandwidth to downstream slave devices. Based on the reference phase information, the bandwidth allocation register 23d outputs a slave device number that indicates which slave device is using the current time slot. It also produces a time slot start signal each time a new time slot begins, as indicated by the numeral (3) in FIG. 12.

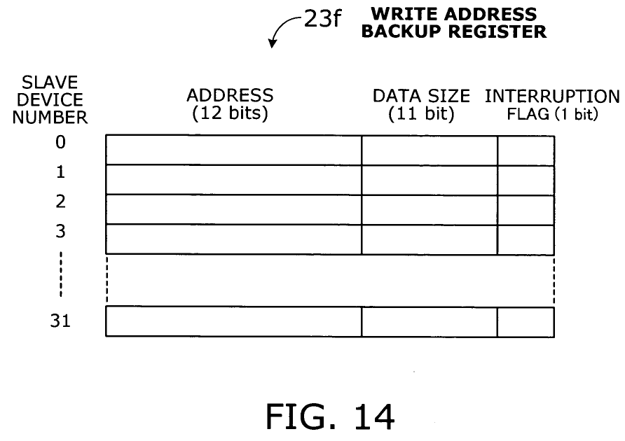

The write address backup register 23f has the following data fields for each individual slave device: address, data size, and interruption flag. The address field is used to record up to which address the buffer area is occupied by packet data words at the point of interruption, and the data size field shows the amount of that stored data words. Address field values are used as a write start address in writing the receive packet buffer 21. The interruption flag is set when the end of the current time slot is reached before the entire packet is written. FIG. 14 shows an example of those data fields constituting the write address backup register 23f.

The write address generator 23c makes access to the write address backup register 23f to retrieve a set of write start address, data size, and interruption flag that correspond to a given slave device number. This data retrieval happens at the next clock cycle after the time slot start signal becomes active, as indicated by the arrows (4) in FIG. 12.

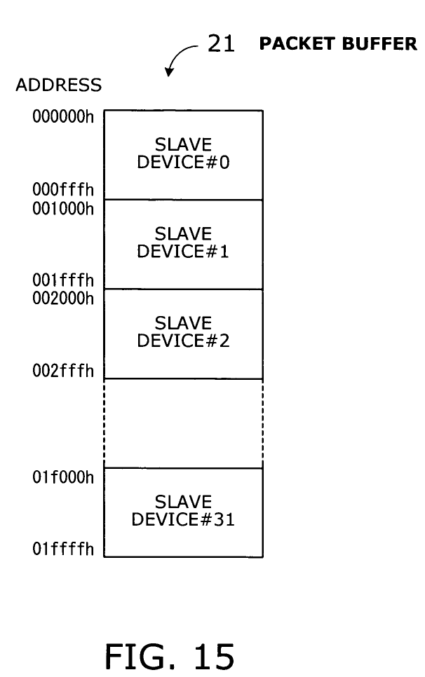

FIG. 15 shows the structure of the packet buffer 21 in the master device 20. The illustrated packet buffer 21 assumes 5-bit slave device numbers and a 12-bit address space for each slave device. Accordingly, the write start address read out of the write address backup register 23f is loaded to lower twelve bits of the write address pointer for the packet buffer 21, as is the slave device number to upper five bits of the same. The data size value is loaded to a data counter in the write address generator 23c. It should be noted here that, if the interruption flag read out of the write address backup register 23f is active, the write address generator 23c increments the corresponding write start address and data size values by one before using them in addressing the packet buffer 21. This correction of address and data size values, however, does not happen in the case that the delimiter detector 22 has produced an end signal in the next clock cycle after the time slot start signal becomes active, because such an end signal asserted at the beginning of a time slot suggests that there is no data to be written into the packet buffer 21.

The interruption flag read out at the timing (4) shown in FIG. 12 is also delivered from the write address generator 23c to the write enable generator 23b. The write enable generator 23b generates a write enable signal for the packet buffer 21 (described later). The write address generator 23c increments its write address pointer each time a data word is written in the packet buffer 21 while the write enable signal is active. In the case this incrementing action conflicts with a loading action to the write address pointer, only the loading action will take place. The data counter in the write address generator 23c is also incremented during the active period of the write enable signal, just as in the write address pointer. At the end of the write enable signal, the data counter is cleared to zero. A loading action to the data counter, however, overrides this clearing action when they happen at the same time.

The write enable generator 23b asserts the write enable signal when a delayed start signal (i.e., a one-clock delayed version of the start signal from the delimiter detector 22) becomes active as indicated by the arrows (5) in FIG. 12. The write enable signal is asserted also when an interruption signal is received from the write address generator 23c as indicated by the arrow (12) in FIG. 12. The exception is when the delimiter detector 22 has produced an end signal in the next clock cycle after the time slot start signal becomes active. If this is the case, the write enable signal remains inactive because the end signal at the beginning of a time slot indicates there is no data to be written into the packet buffer 21. The write enable generator 23b negates the write enable signal either when an end signal is received from the delimiter detector 22, or when a delayed time slot start signal (a one-clock delayed version of the time slot start signal from the bandwidth allocation register 23d) becomes active, as indicated by the arrows (6) in FIG. 12. The latter event may coincide with the aforementioned delayed start signal from the delimiter detector 22. In such a conflicting condition, the write address generator 23c gives priority to the delayed start signal, thus keeping the active state of the write enable signal.

The write address generator 23c latches the current slave device number being supplied from the bandwidth allocation register 23d when the delayed time slot start signal becomes active. The latched slave device number will serve as a backup register selector (described later). The write address generator 23c also produces an interruption monitoring signal. This signal is activated by a start signal from the delimiter detector 22 and negated either by an end signal from the same, or by an interruption detected before an end signal comes. An interruption signal is generated if the bandwidth allocation register 23d produces a time slot start signal during the period where the interruption monitoring signal is active, as indicated by the arrow (7) in FIG. 12.

The write address generator 23c updates the write address backup register 23f at every occurrence of a delayed time slot start signal by recording a set of write start address, data size, and interruption flag corresponding to the slave device number that has been latched as a backup register selector. The arrow (8) in FIG. 12 indicates this update to the write address backup register 23f.

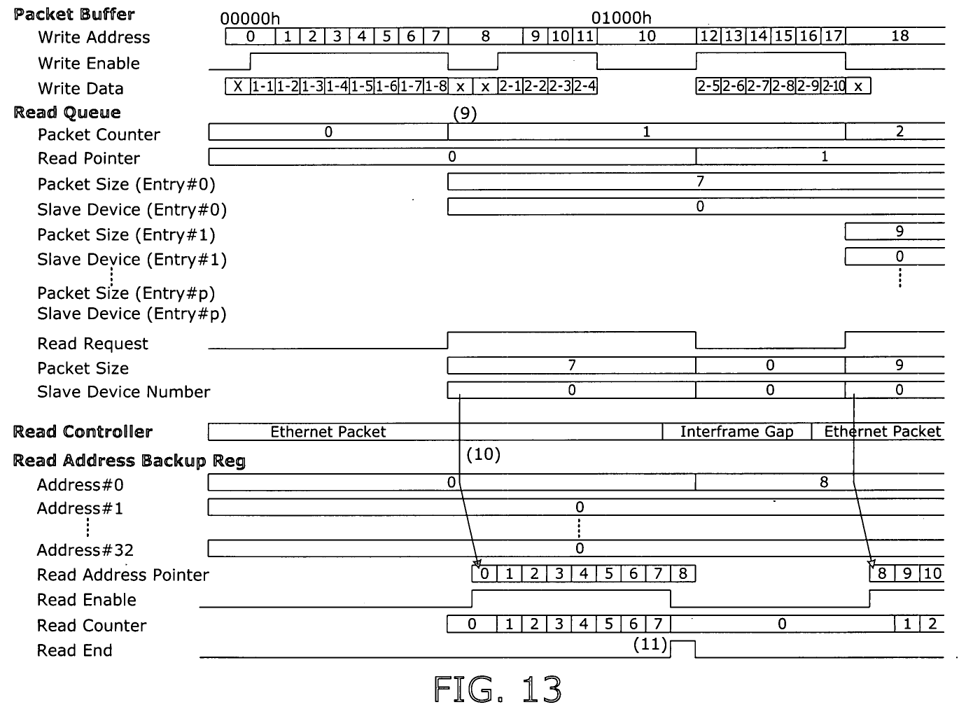

Referring to FIG. 13, the packet buffer 21 receives write data output of the decoder 23a with a delay of one clock cycle. The packet buffer 21 transfers this data to a memory location specified by the write address from the write address generator 23c at each clock during the period where the write enable signal is active.

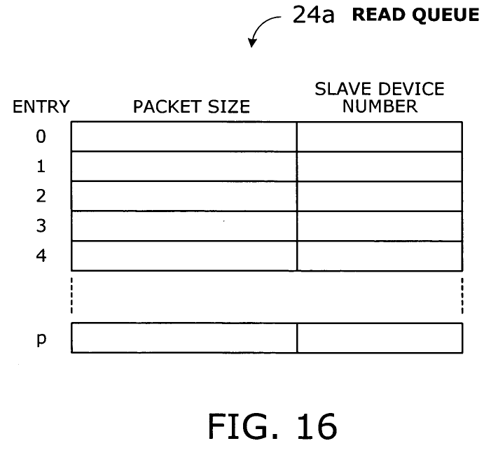

The read queue 24a manages the size and origin of every packet in the packet buffer 21. The end signal from the delimiter detector 22 notifies the read queue 24a of a new packet entry in the packet buffer 21. The read queue 24a then reads the current data counter value from the write address generator 23c and saves it as packet size information into a memory location specified by a packet counter employed in the read queue 24a. The read queue 24a also reads the current backup register selector from the write address generator 23c and saves it in the slave device number field of the same memory location, which indicates which slave device has sent the present packet. Now that a new entry is registered, the read queue 24a increments the packet counter by one as indicated by the numeral (9) in FIG. 13. FIG. 16 illustrates a structure of the read request unit 24.

The read queue 24a has a read pointer to specify which entry to read. When the packet counter goes before the read pointer, it suggests the presence of at lease one packet that should be read out of the packet buffer 21, and the read queue 24a thus issues a read request to the read controller 25a. This request is accompanied by the packet size and slave device number field values of the entry that is currently selected by the read pointer.

In response to the read request from the read queue 24a, the read controller 25a begins reading packet data words out of the packet buffer 21. The read controller 25a is governed by two modes of operation: interframe gap mode and Ethernet packet mode. While the actual interframe gap is 96 bits in length, the description of the present invention assumes a shorter time length for the sake of simplicity. In interframe gap mode, the read controller 25 outputs no data signal. In Ethernet packet mode, the read controller 25 is ready to send, or actually sending packets while reading them out of the packet buffer 21. The read controller 25 makes a transition from interframe gap mode to Ethernet packet mode at the end of every 96-bit gap (actually, the gap size is subject to adjustment, based on read latency time) In response to a read request, the read controller 25a in Ethernet packet mode first retrieves a relevant read address from the read address backup register 25b. The slave device number contained in the read request is used as an index for this retrieval since the packet buffer 21 is divided into a plurality of sections corresponding to individual slave devices. Recall the example packet buffer shown in FIG. 15, whose address consists of upper five bits representing a particular slave device number and lower twelve bits addressing the memory space for a slave device identified by that number. The read controller 25 sets the retrieved read address to lower twelve bits of its address pointer and the slave device number to upper five bits of the same, as indicated by the arrow (10) in FIG. 13.

The read controller 25a sends a read enable signal to the packet buffer 21 at the same time as it sets a read address. The address pointer and read counter are incremented each time a data word is read out during the period when the read enable signal is active. If the read counter value coincides with the packet size provided from the read queue 24a, it means that one whole packet has been read out. The read controller 25a then negates the read enable signal, thus terminating the read operation, clearing the read counter to zero, and writing last value of the read address pointer back to an entry of the read address backup register 25b that is relevant to the current slave device number. The read controller 25a then puts itself into interframe gap mode, issuing a read end signal to the read queue 24a as indicated by the numeral (11) in FIG. 13. This read end signal causes the read queue 24a to advance its read pointer.

The above section has described an embodiment of slave and master devices according to the present invention. In the following, we will present another version of the proposed slave device. The variation intends to improve the efficiency of network transmission by utilizing a remaining frame space to carry an additional packet that has no order-sensitive relationship with the present packets in the frame. To this end, several inventive modifications are made to slave devices, while a conventional structure can be used on the part of master devices.

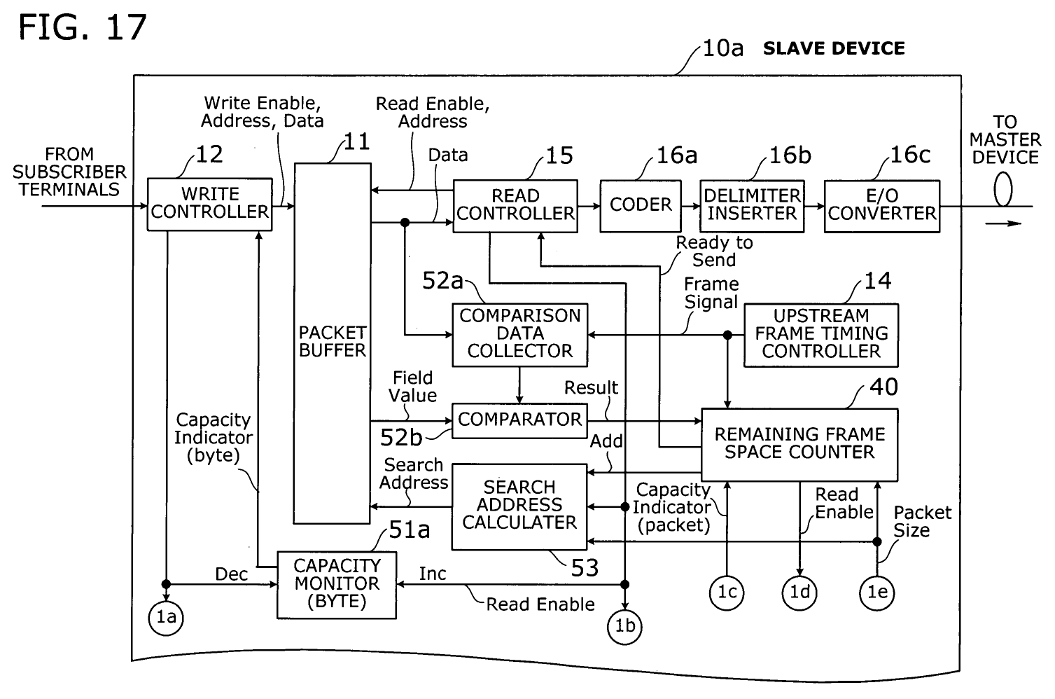

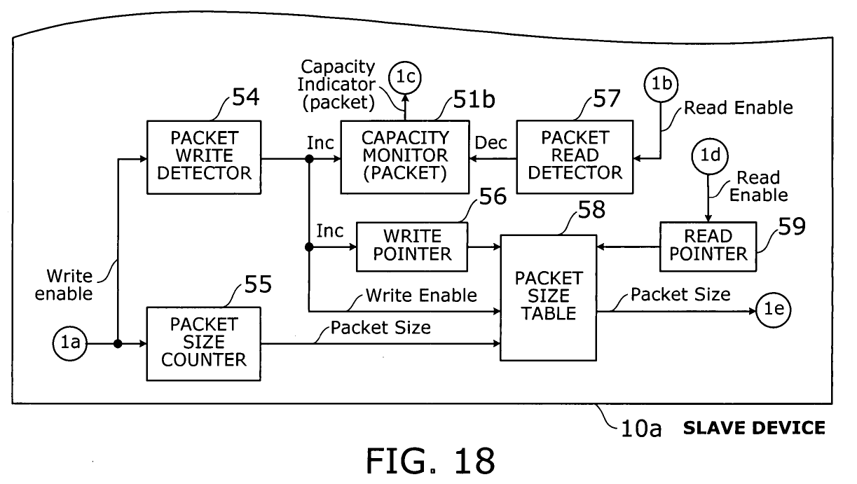

FIGS. 17 and 18 show the structure of a modified slave device. This slave device 10a differs from the one described in FIG. 2 in the following points: First, it employs a capacity monitor (byte) 51a and a capacity monitor (packet) 51b for what was described as the capacity monitor 13 in FIG. 2. Second, it has several new elements including: a comparison data collector 52a, a comparator 52b, a search address calculator 53, a packet write detector 54, a packet size counter 55, a write pointer 56, a packet read detector 57, a packet size table 58, and a read pointer 59. Particularly, the elements 51a, 51b, 52a, and 52b to 59 embody the novel read controller functions of the present invention.

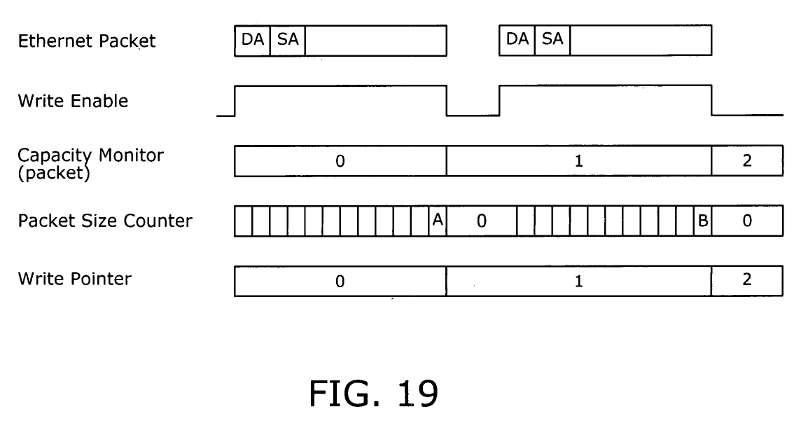

FIG. 19 shows how packets are written in the packet buffer 11. When the packet buffer 11 has received a new packet entry, the packet write detector 54 learns it from the fact that the write controller 12 has negated the write enable signal. The packet write detector 54 then commands the capacity monitor (packet) 51b to increment its packet counter, which represents the number of packets currently available in the packet buffer 11. The packet size counter 55, on the other hand, measures how long the write enable signal is active, thereby identifying the size of the new packet that has just been written in the packet buffer 11.

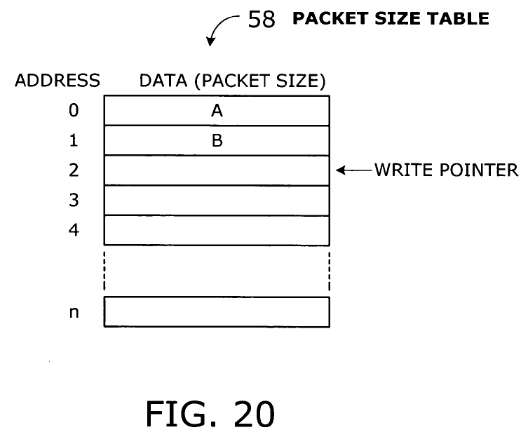

FIG. 20 shows a packet size table. The identified packet size is registered with this packet size table 58, which creates a new table entry at the location specified by the write pointer 56 as FIG. 20 shows. This update to the packet size table 58 occurs upon negation of the write enable signal. The write pointer is advanced simultaneously with incrementing the packet counter in the capacity monitor (packet) 51b.

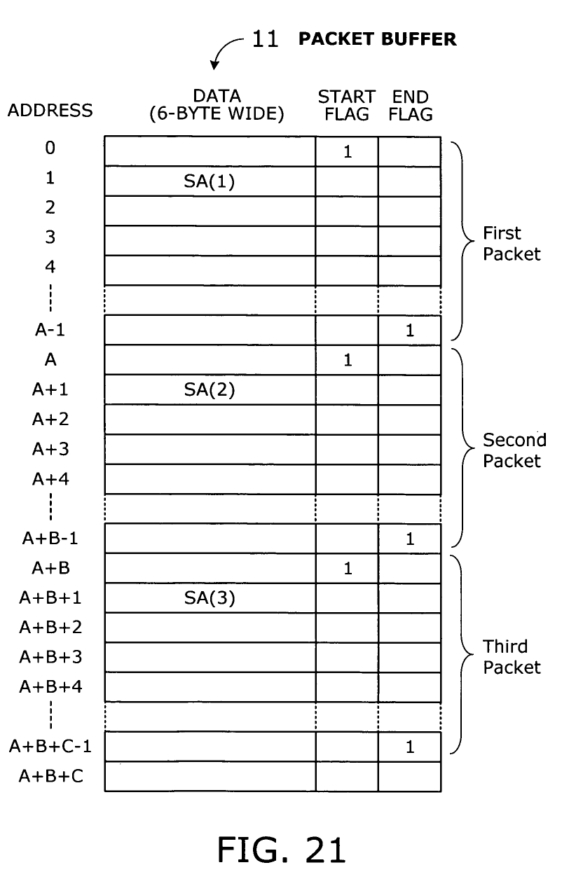

Referring to FIGS. 21 to 23, we will now describe how packets are stored in the packet buffer 11 and how they are read out. FIG. 21 shows how packets are stored in the packet buffer 11. This example depicts three packets with different lengths. The first packet with a length of A occupies a space of address 0 to A-1. The second packet with a length of B occupies a space of address A to (A+B−1). The third packet with a length of C occupies a space of address (A+B) to (A+B+C−1).

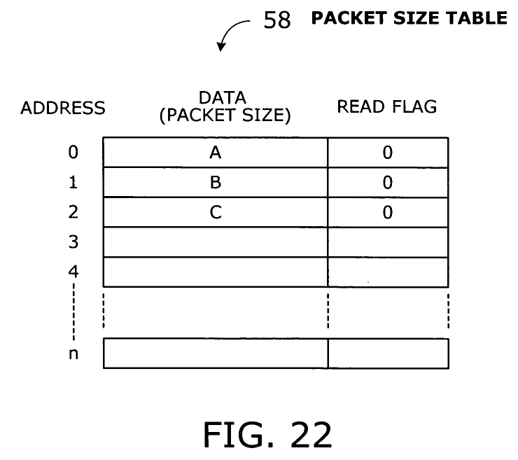

FIG. 22 shows a state of the packet size table 58 that corresponds to the packet buffer 11 of FIG. 21. According to the present invention, the packet size table 58 has a read flag field to manage the state of each entry.

Referring back to FIGS. 17 and 18, the packet size table 58 is updated each time a new packet is entered to the packet buffer 11, being added a table entry describing the size of that packet at the location selected by the write pointer 56. The read pointer 59, on the other hand, specifies which entry to be read out of the packet size table 58. Both the write pointer 56 and read pointer 59 start from address zero, and in normal situations, entries of the packet size table 58 are read out in the order that their corresponding packets were written in the packet buffer 11.

The remaining frame space counter 40 contains a frame usage counter (FC) that increases while the frame signal is active. The remaining frame space is calculated by subtracting FC from a given frame size. When the frame signal is active, and when the capacity monitor (packet) 51b indicates the presence of at least one packet in the packet buffer 11, the remaining frame space counter 40 reads a packet size entry from the packet size table 58. The exception is that, when skipping flag (described later) is active, it consults the packet size table 58 only at the skip check timing (described later).

The remaining frame space counter 40 compares the packet size read out of the packet size table 58 with the remaining frame space calculated. If the packet size is no greater than the remaining frame space, it determines that the packet can be sent in the current frame, thus permitting the read controller 15 to output a read enable signal and read the intended packet from the packet buffer 11. The read enable signal stays active for a period proportional to the packet size.

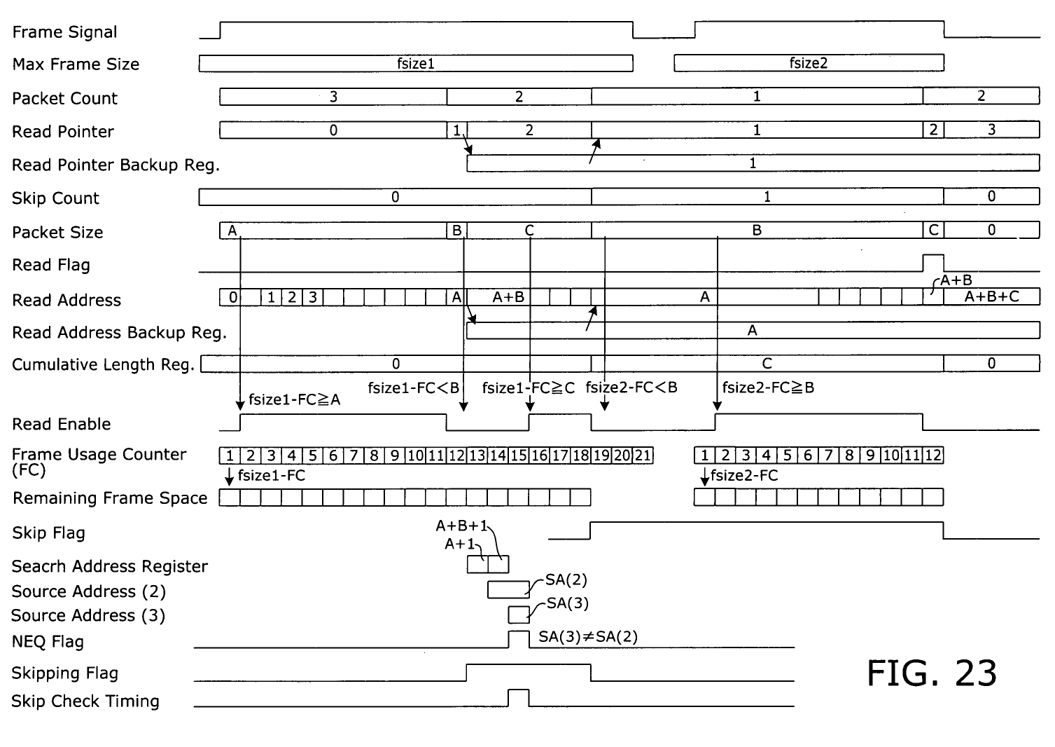

If the packet size is greater than the remaining frame space, it means that the packet does not fit into the current frame. The packet buffer 11 is searched again to determine whether any other suitable packet is available. FIG. 23 is a timing diagram including this process of searching for a packet, which proceeds in the following way:
(1) It is assumed that the packet buffer 11 contains first to third packets in this order, their lengths being A, B, and C, respectively, as shown in FIG. 21.
(2) Upon completion of the first packet transmission, the size of the second packet is examined.
(3) It turns out that the current frame is unable to carry the second packet because its remaining space is insufficient (fsizel-FC<B).
(4) The packet count is two at present, which means that there is yet another packet in the packet buffer 11, other than the second packet, which is unfit for the current frame. Skip processing is now invoked in the hope that the third packet may fit in the remaining frame space. Skipping flag is thus set to “1” to indicate that the skip processing is under way.
(5) To make access to the next packet information in the packet size table 58, the read pointer 59 is incremented by one, thus yielding a value of “12.” Before doing that, the current read pointer “1” is saved in a read pointer backup register. The current read address “A” of the read controller 15 is also saved in a read address backup register. The read address is now changed to (A+B), the sum of the present address “A” and the packet size “B,” to point at the top of the third packet.

Further, in the present embodiment, the search address calculator 53 calculates the next-to-top address by adding an offset of 1 to the above read address (A+B). The resulting address (A+B+1) is set to a search address register in the search address calculator 53, which is used to compare source addresses in the subsequent step.
(6) The search address register permits a particular field value (the source address in the present case) of the third packet to be read out of the packet buffer 11. The source address SA(2) of the second packet, which would be skipped, is recorded in the comparison data collector 52a. The comparator 52 then compares the source address value SA(3) of the third packet with the value SA(2) of the second packet. If SA(3) is different from SA(2), a not-equal (NEQ) flag is set as shown in FIG. 12. It is then determined whether the remaining frame space is not smaller than the size of the third packet. Further, it is determined whether the read flag of the third packet is zero. If all the above three tests yield positive results (i.e., all conditions are true), it means that the current frame can carry the third packet. The third packet is then read out of the packet buffer 11 for transmission.
(7) Upon completion of reading the third packet, the read pointer restores its previous state from the read pointer backup register, and so does the read address from the read address backup register. This restoration permits the packet size table 58 and read controller 15 to look at the second packet again, being ready for sending it in the next assigned time slot. The skip count is then incremented, and the cumulative length register is updated with an additional length value (in the present context, it is the length C of the third packet). Now that the skip processing is finished, the skipping flag is cleared to zero, and for the record of the skip processing, a skip mode flag is set.

As can be seen from the above sequence, the slave device is designed to utilize its assigned time slots more efficiently by sending an appropriate packet earlier than other packets pending in the packet buffer if its source address is different from that of the skipped packet. Such modification to the order of packets is transparent to the receiving end as long as those packets originate from different source addresses. This is as opposed to a series of packets sent from the same source address, which must be delivered to the destination in the intended order, thus requiring the receiving end to correct the order if it is changed at the sending end.

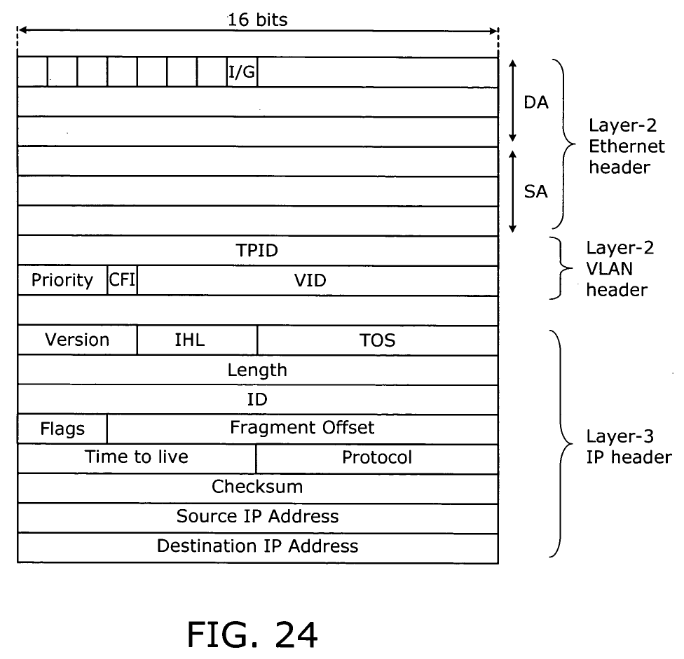

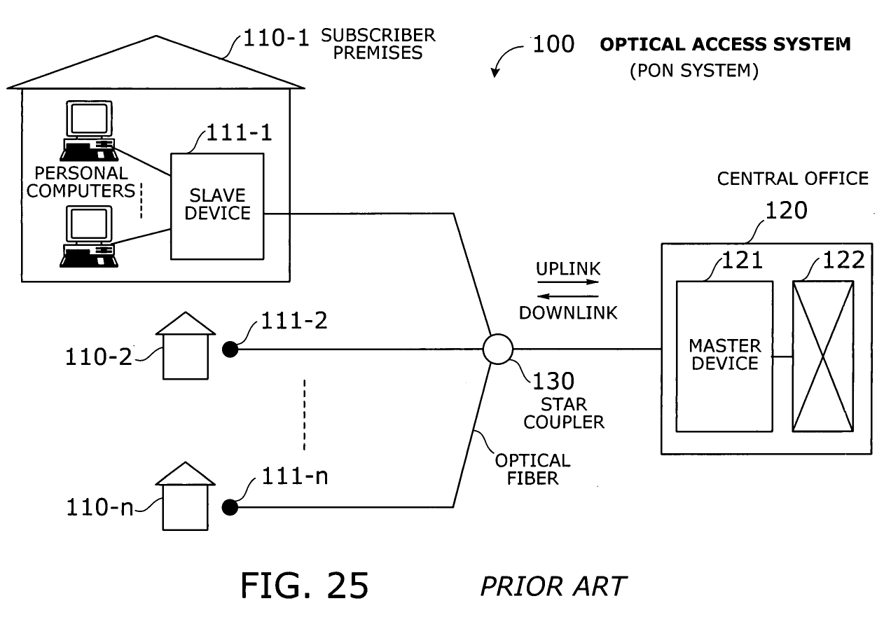

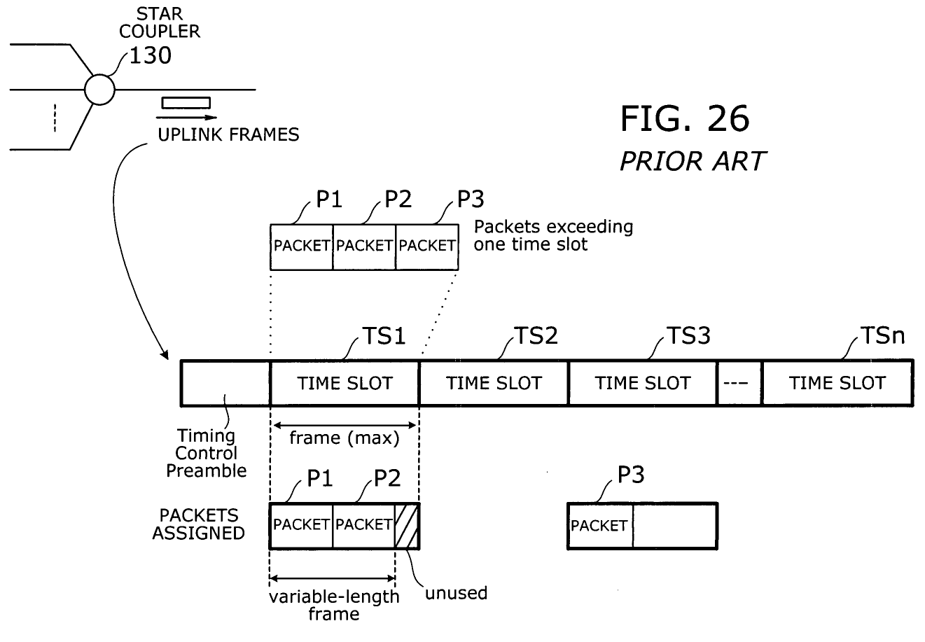

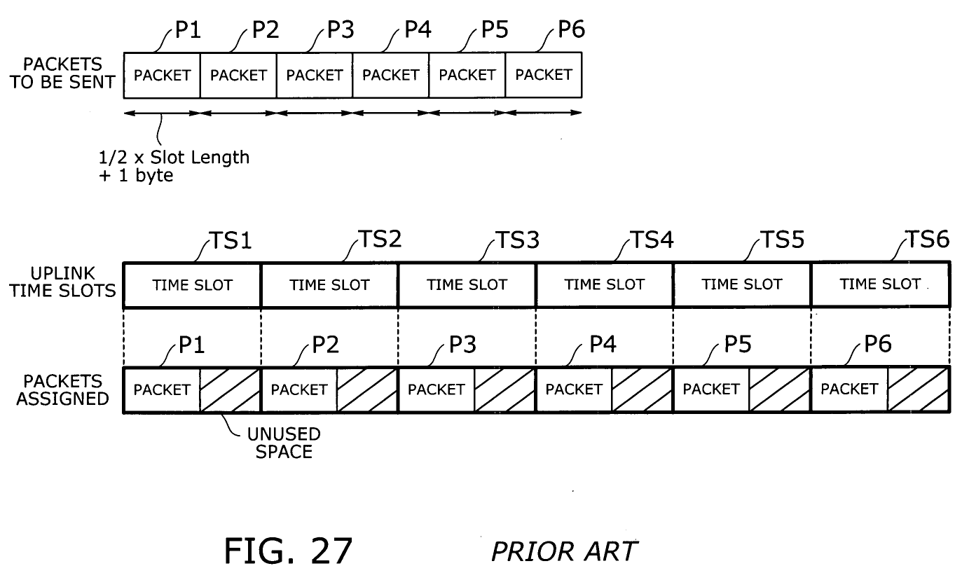

FIG. 24 shows the structure of packet headers. While we have assumed the use of source address (SA) field in the skip processing described in FIG. 23, some of other header parameters could serve the same purpose. For example, the destination address (DA) of layer-2 MAC frames can be used instead of the source address. In this case, the search address calculator 53 adds an offset of zero to the above read address to calculate the location of DA field in the packet buffer 21.

Suppose that the next packet pending in the buffer is too large to fit in the current frame. If there is another pending packet that has a different DA from that of the unfit packet, and if it fits in the remaining frame space, the slave device can send that packet earlier than the unfit packet. Such modification to the order of packets would do no harm because those packets are delivered to different destinations.

Another alternative to the source address field is Priority subfield in Tag field of layer-2 MAC frame header. If there is a pending packet that has a different priority from that of the unfit packet, and if it fits in the remaining frame space, the slave device can send that packet earlier than the unfit packet. Such modification to the order of packets would do no harm because those packets belong to different priority groups.

Yet another alternative is VID (VLAN ID) subfield in Tag field of layer-2 MAC frame header. If there is a pending packet that has a different VID from that of the unfit packet, and if it fits in the remaining frame space, the slave device can send that packet earlier than the unfit packet. Such modification to the order of packets would do no harm because those packets belong to different VLANs.

Still another alternative is Individual/Group (I/G) bit of layer-2 MAC frame header. If there is a pending packet that has a different I/G bit value from that of the unfit packet, and if it fits in the remaining frame space, the slave device can send that packet earlier than the unfit packet. Such modification to the order of packets would do no harm because what the frame carries is a combination of different kinds of packets. Think of, for example, a frame solely containing unicast packets (I/G=0). This frame will be able to carry an additional broadcast packet (I/G=1) if there is enough space left. Reversely, a frame that only contains broadcast packets can accept an additional unicast packet if space allows.

Still another alternative is Type field of layer-2 MAC frame header. If there is a pending packet that has a different Type field value from that of the unfit packet, and if it fits in the remaining frame space, the slave device can send that packet earlier than the unfit packet. Such modification to the order of packets would do no harm because those packets are of different types.

Still another alternative is the destination IP address field of layer-3 IP packet header. If there is a pending packet that has a different destination IP field value from that of the unfit packet, and if it fits in the remaining frame space, the slave device can send that packet earlier than the unfit packet. Such modification to the order of packets would do no harm because those packets are delivered to different destinations.

Still another alternative is the Protocol field of layer-3 IP packet header. If there is a pending packet that has a different protocol field value from that of the unfit packet, and if it fits in the remaining frame space, the slave device can send that packet earlier than the unfit packet. Such modification to the order of packets would do no harm because those packets are based on different protocols.

Still another alternative is the Type of Service (TOS) field of layer-3 IP packet header. If there is a pending packet that has a different TOS field value from that of the unfit packet, and if it fits in the remaining frame space, the slave device can send that packet earlier than the unfit packet. Such modification to the order of packets would do no harm because those packets belong to different priority groups.

Still another alternative is a combination of SA and Type fields of layer-2 MAC frame header. If there is a pending packet that has a different SA field value or a different Type field value from those of the unfit packet, and if it fits in the remaining frame space, the slave device can send that packet earlier than the unfit packet. Such combined classifications of packets increase the usage of time slots.

Still another alternative is a combination of destination IP address and protocol fields of layer-3 IP packet header. If there is a pending packet that has a destination IP address or a different protocol field value from those of the unfit packet, and if it fits in the remaining frame space, the slave device can send that packet earlier than the unfit packet. Such combined classifications of packets increase the usage of time slots.

As can be seen from the above explanation, the proposed optical access system is designed to send packets more efficiently without wasting bandwidth. The uplink channel from slave devices to a master device is divided into time slots. The sending slave device reads out upstream packets from its send packet buffer when an assigned time slot comes. If the maximum frame size is reached in the middle of a packet, the slave device suspends further reading until a next assigned time slot comes. The packets are sent to the master device, each being set off by a start and end delimiters. Detection of a start delimiter causes the master device to begin writing each received data word into a receive packet buffer, which is terminated by the end delimiter of that packet. Received packets are read out of their memory locations specified by a read address that includes the sender's slave device number. This structural arrangement of the present invention prevents time slot resources from being wasted, thus improving the efficiency of packet transmission.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. An optical access system that connects subscriber premises with a central office by using optical communications techniques, the system comprising:
(a) a slave device identified by a slave device number, comprising:
a send packet buffer that stores packets to be sent,
a sending-end write controller that writes a packet in said send packet buffer,
a capacity monitor that watches usage of said send packet buffer and outputs a capacity indicator representing the amount of unused memory space in said send packet buffer,
an upstream frame timing controller that produces a frame signal representing a bandwidth allocated to said slave device for upstream data transmission, the frame signal being active during a period corresponding to a maximum frame size, and
a sending-end read controller that reads the packets out of said send packet buffer when the frame signal is active and the capacity indicator indicates presence of packets pending in said send packet buffer, wherein said sending-end read controller suspends said reading of packets when the maximum frame size is reached and resumes the suspended reading next time the frame signal becomes active; and
(b) a master device comprising:
a receive packet buffer that stores packets received from the slave device in a memory space that is associated with the slave device number of the sending slave device,
a delimiter detector that produces a start signal upon detection of a start delimiter of a received packet, and an end signal upon detection of an end delimiter of the received packet,
a receiving-end write controller that starts writing the received packet into said receive packet buffer upon receipt of the start signal from said delimiter detector and stops writing the received packet into said receive packet buffer upon receipt of the end signal from said delimiter detector,
a read request unit that issues a read request for the received packet upon issuance of the end signal, and
a receiving-end read controller that reads, in response to the read request, the received packet out of the memory space of said receive packet buffer by giving a read address that includes the slave device number of said slave device.

2. A slave device located in a subscriber's premises for use in an optical access system, the slave device comprising:
a send packet buffer that stores packets to be sent;
a sending-end write controller that writes a packet in said send packet buffer;
a capacity monitor that watches usage of said send packet buffer and outputs a capacity indicator representing the amount of unused memory space in said send packet buffer;
an upstream frame timing controller that produces a frame signal representing a bandwidth allocated to said slave device for upstream data transmission, the frame signal being active during a period corresponding to a maximum frame size; and
a sending-end read controller that reads the packets out of said send packet buffer when the frame signal is active and the capacity indicator indicates presence of packets pending in said send packet buffer, wherein said sending-end read controller suspends said reading of packets when the maximum frame size is reached and resumes the suspended reading next time the frame signal becomes active.

3. A master device located in a central office for use in an optical access system, the master device comprising:
a receive packet buffer that stores packets received from a slave device in a memory space that is associated with a slave device number of the sending slave device;
a delimiter detector that produces a start signal upon detection of a start delimiter of a received packet, and an end signal upon detection of an end delimiter of the received packet;
a receiving-end write controller that starts writing the received packet into said receive packet buffer upon receipt of the start signal from said delimiter detector and stops writing the received packet into said receive packet buffer upon receipt of the end signal from said delimiter detector;
a read request unit that issues a read request for the received packet upon issuance of the end signal; and
a receiving-end read controller that reads, in response to the read request, the received packet out of the memory space of said receive packet buffer by giving a read address that includes the slave device number of said slave device.

4. An optical access system that connects subscriber premises with a central office by using optical communications techniques, the system comprising:
(a) a slave device comprising:
a send packet buffer that stores packets to be sent,
a sending-end write controller that writes a packet in said send packet buffer,
a remaining frame space counter that calculates remaining frame space by subtracting the amount of packets in a current frame from a given frame size, and
a read controller that, when the remaining frame space is insufficient for a next pending packet, searches said send packet buffer to identify a packet that fits in the remaining frame space and has no order-sensitive relationship with the next pending packet, and reads the identified packet out of said send packet buffer earlier than the next pending packet; and
(b) a master device that receives upstream data from the slave device and sends downstream data to the slave device.

5. The optical access system according to claim 4, wherein said read controller identifies a packet as having no order-sensitive relationship when said packet is different from the next pending packet in terms of Source Address field values of layer-2 MAC frame header.

6. The optical access system according to claim 4, wherein said read controller identifies a packet as having no order-sensitive relationship when said packet is different from the next pending packet in terms of Destination Address field values of layer-2 MAC frame header.

7. The optical access system according to claim 4, wherein said read controller identifies a packet as having no order-sensitive relationship when said packet is different from the next pending packet in terms of Priority values in TAG field of layer-2 MAC frame header.

8. The optical access system according to claim 4, wherein said read controller identifies a packet as having no order-sensitive relationship when said packet is different from the next pending packet in terms of VLAN ID (VID) values in TAG field of layer-2 MAC frame header.

9. The optical access system according to claim 4, wherein said read controller identifies a packet as having no order-sensitive relationship when said packet is different from the next pending packet in terms of Individual/Group (I/G) bit values of layer-2 MAC frame header.

10. The optical access system according to claim 4, wherein said read controller identifies a packet as having no order-sensitive relationship when said packet is different from the next pending packet in terms of Type field values of layer-2 MAC frame header.

11. The optical access system according to claim 4, wherein said read controller identifies a packet as having no order-sensitive relationship when said packet is different from the next pending packet in terms of Destination IP Address field values of layer-3 IP header.

12. The optical access system according to claim 4, wherein said read controller identifies a packet as having no order-sensitive relationship when said packet is different from the next pending packet in terms of Protocol field values of layer-3 IP header.

13. The optical access system according to claim 4, wherein said read controller identifies a packet as having no order-sensitive relationship when said packet is different from the next pending packet in terms of Type of Service (TOS) field values of layer-3 IP header.

14. The optical access system according to claim 4, wherein said read controller identifies a packet as having no order-sensitive relationship when said packet is different from the next pending packet in terms of both Source Address field values and Type field values of layer-2 MAC frame header.

15. The optical access system according to claim 4, wherein said read controller identifies a packet as having no order-sensitive relationship when said packet is different from the next pending packet in terms of both Destination IP Address field values and Protocol field values of layer-3 IP header.

16. A slave device located in a subscriber's premises for use in an optical access system, the slave device comprising:
a send packet buffer that stores packets to be sent;
a sending-end write controller that writes a packet in said send packet buffer,
a remaining frame space counter that calculates remaining frame space by subtracting the amount of packets in a current frame from a given frame size; and
a read controller that, when the remaining frame space is insufficient for a next pending packet, searches said send packet buffer to identify a packet that fits in the remaining frame space and has no order-sensitive relationship with the next pending packet, and reads the identified packet out of said send packet buffer earlier than the next pending packet.
